(19) United States
(12) Patent Application Publication
(10) Pub. No.: US 2018/0223001 A1
(43) Pub. Date: Aug. 9, 2018

(54) NOVEL METHOD FOR THE POLYMERIZATION OF SUGARS

(71) Applicants: Centre national de la recherche scientifique, PARIS (FR); UNIVERSITE DE POITIERS, Poities Cedex (FR)

(72) Inventors: François JEROME, SEVRES-ANXAUMONT (FR); Karine DE OLIVEIRA VIGIER, FONTAINE LE COMTE (FR); Joakim DELAUX, POITIERS (FR); Elodie FOURRE, POITIERS (FR); Jean-Michel TATIBOUËT, POITIERS (FR)

(21) Appl. No.: 15/748,482

(22) PCT Filed: Jul. 28, 2016
(86) PCT No.: PCT/EP2016/068116

§ 371 Date: Jan. 29, 2018

(30) Foreign Application Priority Data
Jul. 30, 2015 (FR) 15 57325

(51) Int. Cl. C08B 37/00; H05H 1/24

(52) U.S. Cl. CPC C08B 37/0006; H05H 2240/20; H05H 2001/2412; H05H 1/2406

(57) ABSTRACT

The present invention relates to a method for preparing a polysaccharide comprising a step of the polymerization of a saccharide monomer by non-thermal plasma treatment.

The subject of the present invention is a novel method for the polymerization of sugars, which makes it possible to obtain hyperbranched and/or compact polysaccharides in solid form.

In the search to reduce greenhouse gas emissions, the chemical industry faces major scientific and technological challenges in adapting or designing new methods and commercializing new products. In order to sustainably reduce the carbon footprint while keeping in mind the imperatives of economic, societal and environmental competitiveness, the chemical industry is actively seeking new technologies.

Plasma is an ionized gas that may or may not be in thermodynamic equilibrium. This technology is widely used especially for surface treatment and the decontamination of water or air. Plasma-assisted polymerization is commonly used for the deposition of organic polymers on inorganic or organic substrates. However, in all cases, the use of volatile and ionizable monomers is necessary so that the latter may be in the gas phase in the plasma zone. Therefore, simple monomers are mainly used among which are included furans, acrylonitrile, styrene, acetylene, etc. In addition, in current methods, plasma-produced polymers are graft polymers as they develop on the surface of a solid support.

Until now, the preparation of polysaccharides is essentially effected according to two technologies, namely: acid catalyzed polymerizations or enzymatic methods. However, these methods have many disadvantages, for example the production of secondary products such as furan and humic compounds requires the implementation of purification steps. In addition, the enzymatic methods are carried out in water and require an effluent treatment step.

Also, to date, there has been a need for a method avoiding the aforementioned disadvantages, and, in particular, overcoming the need for purification steps after polymerization.

It is an object of the present invention to provide a rapid method for obtaining a polysaccharide but without a step to purify the polysaccharide.

Another object of the present invention is to provide a rapid method with high productivity.

Another object of the present invention is to provide a dry method (i.e. without using a solvent) that does not require the use of a catalyst or a solid support.

Thus, the present invention relates to a method for preparing a polysaccharide comprising a step for non-thermal plasma polymerization of a saccharide monomer.

The method of the invention therefore consists in polymerizing at least one saccharide monomer by plasma treatment. This polymerization is also called plasma-assisted polymerization. The distinctive feature of the method of the invention is therefore the presence of a plasma for the polymerization of sugars.

The present invention is based on the use of plasma technology to prepare polysaccharides from saccharide monomer.

According to the method of the invention, the polymerization step is not carried out in the presence of a solid support.

The method of the invention is, therefore, different from a plasma surface treatment method because it does not involve the placing of the saccharide monomer on a support to be treated. The method of the invention makes it possible to dispense with the use of a solid support, which allows a gain in terms of efficiency because the method does not include a step of recovering and purifying the polysaccharide produced.

A plasma is a partially or totally ionized gas. It consists of electrons and ions, possibly atoms or molecules. There are different types of plasma which broadly differentiate between thermal plasma and non-thermal plasma.

Thermal plasma is in fact the state of a gas heated to a very high temperature (i.e. greater than 3000° C.). At this temperature, the gas is strongly ionized. There is therefore the simultaneous presence of free electrons and positively charged species, wherein these different species are in a state of equilibrium, and this state persists as long as the temperature remains the same. In particular, among thermal plasma technologies, mention may be made of high frequency and radio frequency plasma technologies.

Non-thermal plasma or out of equilibrium (or cold plasma) corresponds to a transitory state of ionization of the gas during which there is formation of free electrons and thus of positively charged species, which will very quickly recombine or react to again form a neutral, non-ionized gas, wherein the gas is mainly at a low or moderate temperature. In general, to create a non-thermal plasma, the gas must be subjected to an intense electric field in order to generate a method of acceleration of the few free electrons still present in the gases and resulting, for example, from the action of cosmic rays. These few electrons, very strongly accelerated by the electric field, are then able, by inelastic shocks, to tear electrons from the gas molecules, which in turn are accelerated. This method is called an “electronic avalanche” and is the initiation step of non-thermal plasma. These highly energetic electrons are then able to activate the molecules of the gas, either by transferring some of their energy or even by breaking chemical bonds, thus making these species very reactive and therefore able to react, even if the average conditions of the gas do not allow it.

The way of applying the electric field thus differentiates the types of non-thermal plasma. To achieve an intense electric field that is required for the formation of plasma, it is necessary to apply a significant electrical potential difference (often greater than 10,000V) between two electrodes.

It is possible to generate the electric field between two electrodes of very different shapes (a tip and a plane, for example), or to isolate one or both electrodes by a dielectric material. In the case of electrodes of different geometry, we speak of “corona” plasma or corona discharge, wherein the plasma only develops around the electrode having the smallest radius of curvature (point effect), and this plasma may be generated by either a DC voltage or an AC voltage. In the case where electrodes are insulated by a dielectric material, it is referred to as “dielectric barrier discharge” and the plasma may only be generated by the application of an AC voltage.

Many different geometries have been derived from these basic conformations, both in the case of “corona” plasma and dielectric barrier discharge. In the case of dielectric barrier discharges, it is also possible to mention the surface plasma which has the particularity of being generated directly on the surface of the dielectric, wherein the electrodes are applied on either side of this dielectric.

There is third way proceeding from either the electric arc or the “corona” discharge, referred to as “gliding discharge” or blown arc or “Glidarc”, which results from the observation that during the formation of an electric arc, a non-thermal plasma is briefly formed before the onset of the electric arc at the beginning of the ionization of the gas under the influence of the electric field. The method then consists of literally blowing the ions and electrons by means of a strong gas flow in order to always remain below the concentration of ions and electrons necessary for the formation of the electric arc. Simultaneously, a particular shape of the facing electrodes whose separation is not constant, makes it possible to avoid too high a value of the electric field and the risk of formation of the arc. In practice, the discharge is initiated at the point where the electrodes are closest, and then develops, as it is pushed by the gas flow into the area where the electrodes progressively diverge.

Finally, it is also possible to achieve a real plasma jet by forming a non-thermal plasma near the orifice of a narrow tube in which a fast gas flow circulates. In this case, the species generated by the plasma are literally projected outwards in the form of a dart that is equivalent to that of a torch and allows, for example, the treatment of surfaces of materials.

Whatever the type of plasma considered, it may be carried out under reduced pressure or at atmospheric pressure, or even at a higher pressure.

According to a preferred embodiment, the plasma used according to the invention is a non-thermal atmospheric plasma (NTAP).

Preferably, the method of the invention is carried out with a dielectric barrier discharge plasma. According to this embodiment, the energy required for the creation of the cold plasma is obtained by applying a strong electric field between two electrodes, and that is generated by the application of a high electrical voltage between these electrodes, either in the form of a voltage pulse or an alternating voltage. The dielectric barrier discharge plasma (DBD) is formed when a dielectric material (glass, quartz, ceramic, alumina . . . ) is placed between the two electrodes, thus preventing the passage of an electric arc. The presence of the dielectric material also allows the formation of a more homogeneous plasma that is distributed over the entire surface of the electrodes.

Preferably, when a dielectric barrier discharge plasma is applied, the saccharide monomer is deposited directly between the electrodes without the presence of an additional solid support.

According to one embodiment, the saccharide monomer is a monosaccharide or a disaccharide.

Preferably, the saccharide monomer is a monosaccharide.

Among monosaccharides used according to the invention are included glucose, mannose, galactose or xylose.

Among the disaccharides used according to the invention, mention may be made of maltulose, isomaltulose, maltose or turanose.

Preferably, the saccharide monomer is in the form of a powder.

The polysaccharides obtained according to the method of the invention are polymers or copolymers. In fact, the method of the invention may be a polymerization or copolymerization method.

As indicated above, the method of the invention makes it possible to synthesize polysaccharides which may also be equally referred to as “sugars” or “carbohydrates”.

According to the invention, the carbohydrates have the general formula Cₓ(H₂O)_{y}. They may also be functionalized, in particular by —CO₂H, —CHO, —NR₂ (R═H, alkyl, aromatic), ether, phosphate or sulfate groupings.

The polysaccharides obtained according to the invention are hyperbranched polymers and/or compact or related to dendritic polymers (or dendrimers). They are obtained in solid form.

The method of the invention advantageously makes it possible to obtain the polysaccharide directly and, preferably, does not comprise a subsequent purification step, contrary to the usual methods of the prior art.

The method advantageously makes it possible to control the degree of polymerization of the polysaccharides obtained. It is therefore possible, for example, to stop the polymerization when desired and thus to control the degree of polymerization and the molecular weight.

Preferably, the polysaccharides obtained according to the method of the invention have molar masses ranging from 1000 g/mol to 100,000 g/mol. They may have degrees of polymerization (DP) from 3 to 400 and their hydrodynamic radii may range from 0.8 to 40 nm.

According to one embodiment, the polymerization step is carried out at a temperature below the melting temperature of the saccharide monomer, which allows the method to be carried out at a temperature at which the saccharide monomer is solid.

Preferably, the polymerization step is carried out at a temperature between 0° C. and 140° C., preferably between 0° C. and 100° C.

Advantageously, the polymerization step of the method of the invention is carried out without a catalyst or solvent.

The polysaccharides obtained according to the invention are solid and white products which do not require a post-treatment step (such as effluent recycling, purification, discoloration steps, etc.) after polymerization, unlike the methods of the prior art.

Preferably, the polymerization step is carried out for a period of less than 30 minutes, preferably of between 5 and 20 minutes.

The method according to the invention may comprise a first step which involves placing at least one saccharide monomer in a gaseous medium capable of forming a plasma. Preferably, the saccharide monomer is placed between two electrodes that are, in particular, insulated from each other by a dielectric material.

According to one embodiment, the method according to the invention also comprises a step of forming the plasma, in particular by heating the gaseous medium at a very high temperature (thermal plasma) or by subjecting this medium to an intense electric field (non-thermal plasma). Preferably, the gaseous medium is subjected to an electric field of at least 5·10⁵ V/m.

According to a preferred embodiment, the method according to the invention comprises the following steps:
placing a saccharide monomer between two electrodes insulated from each other by a dielectric material, and preferably separated by a distance of between 4 mm and 10 mm;
application of an electric field between the two electrodes greater than 5·10⁵V/m to generate a plasma discharge between the two electrodes;
formation of a polysaccharide by polymerization of the saccharide monomer; and
the possible recovery of the polysaccharide thus formed.

According to one embodiment, the voltage used for the method of the invention is between 8.5 kV and 10.5 kV.

According to the melting temperature of the saccharide monomer, as mentioned above, the method of the invention may further comprise a preliminary step of heating or cooling the reaction medium (corresponding to the space (or reactor) formed by the electrodes).

### EXAMPLES

### Example 1 Polymerization of Mannose

The mannose was placed in the solid state between two copper electrodes of 25 cm² arranged in parallel and isolated from one another by a dielectric (called a DBD reactor). In order to maintain the formation of an optimal plasma, the gap between the two electrodes was set at 4 mm. The plasma was created using a bipolar generator at a voltage of 9.5 kV and a frequency of 2.2 KHz. The air flow is 100 mL/min. During the plasma treatment, mannose samples were taken after 10, 15 and 30 min and then analyzed by steric exclusion chromatography (SEC). It was found that mannose is completely consumed after only 15 minutes of plasma treatment and that products of higher molecular weight are formed.

The polymerization of mannose may also be observed indirectly by X-ray diffraction (XRD) analysis and by ¹H and ¹³C NMR. In fact, after plasma treatment, a significant broadening of the signals is observed in both types of analysis which is often the sign of an anarchic (or disordered) polymerization.

Interestingly, it may be observed on the MALDI-TOF spectra that the polymerization actually starts after 7 min of plasma treatment. The conversion of mannose as a function of the plasma treatment time has been studied by SEC in order to obtain more information on this aspect. In agreement with the MALDI-TOF analyzes, an induction period of 7 min was observed by SEC after which the mannose is rapidly polymerized in only 3 min. This induction period is related to the increase in the temperature of the plasma reactor (provided by the dissipated energy). In particular, this induction period corresponds to the time required for the reactor to reach 40° C. In order to support this hypothesis, the plasma reactor was initially cooled to −23° C. In this case, the time required for the reactor to reach 40° C. passed from 7 to 15 min, which coincides with an extension of the induction period from 7 to 15 min. Similarly, when the reactor is at 65° C. or 75° C. when placed at the start of treatment, there is no induction period and polymerization begins almost instantaneously. Finally, when the plasma reactor is successively started and then stopped in order to avoid an increase in temperature above 40° C., no polymerization takes place and the mannose remains unconverted. All of these results suggest that mannose polymerization begins when the external temperature of the reactor reaches 40° C.

Analysis of Mannose Polymers

The mannose polymers were analyzed by various techniques. At first, IR and RAMAN spectroscopy was used. No characteristic signal of a C═O or C═C group was determined thus again confirming the stability of the mannose units during the plasma treatment. Solid or liquid NMR analysis (¹H and ¹³C) confirms this observation and no characteristic peak of a C═O group was observed. These results are surprising considering that the species generated by the plasma are often used for oxidation reactions. In order to obtain further information, the mannose polymers were analyzed by X-ray photoelectron spectrometry (XPS) which provides information on the chemical composition of a surface in a 10 nm layer. Interestingly, XPS reveals oxidation of the surface of the mannose polymer particles with the presence of O—C═O groups with about one —C═O for three mannose units. The oxidation of the surface of the mannose particles is also supported by the measurement of the pH (at 10 g/L) which decreases from 6 to 4.2 after plasma treatment in agreement with the production of a small amount of CO₂H group. It should be noted that when the mannose is impregnated with an acetic acid solution in order to lower its pH to 4.2 and then treated at 50° C. for 15 min in the solid state, no polymerization takes place which suggests that the acidic species formed on the surface of the mannose are not responsible for the polymerization observed. Moreover, the mannose conversion rate remains similar, regardless of the initial plasma reactor temperature which suggests that the activation energy is very low, which is in agreement with a radical mechanism.

In order to collect more information at a molecular level, the mannose polymers were analyzed by GC/MS using commercial standards for assignment of different peaks. More particularly, we focused on the disaccharide fraction in order to determine the different positions of the mannose involved in the polymerization. Disaccharide fraction analysis was performed at a mannose conversion of 43% so that the signals could be more accurately quantified. These analyses reveal that all the hydroxyl groups are involved in the polymerization of mannose. However, the link between two mannose units is primarily between positions 1 and 6 (71% probability). Selectivity between α-1,6 and β-1,6 bonds is 27% and 44%, respectively. It is clear that the polymerization of mannose takes place in a disordered manner which rationalizes the signal expansions observed by XRD and NMR.

The mannose polymers were analyzed by SEC/MALS to obtain information on the mass distribution and conformation of the mannose polymers. Elution profiles show at least three different types of populations that differ in their hydrodynamic volume, reflecting a strong polydispersity. These analyses reveal that the molar masses of the mannose polymer range from 2×10³ to 9×10⁶ g/mol with a hydrodynamic radius ranging from 1.2 to 37.2 nm. More generally, the mannose polymers are characterized by a mean molar mass (M_{w}) of 95.590 g/mol, an intrinsic viscosity (η) of 7.7 ml/g and a hydrodynamic radius (Rh) of 3.3 nm. The mannose polymers also exhibit a high polydispersity (M_{w}/Mₙ) of 15 which, again, is consistent with disordered mannose polymerization.

The conformation of mannose polymers was then studied by plotting Rh as a function of M_{w}. Rh and M_{w} are bonded together and obey equation (1) where Rh and M_{w} are respectively the hydrodynamic radius and the molar mass, vₕ is the hydrodynamic coefficient and Kₕ is a constant.

Rh═KₕM_{w}^{υ}^{ₕ} equation (1)

The hydrodynamic coefficient depends on the general shape of the macromolecules, the temperature and the macromolecule-solvent interactions. A theoretical vₕ of 0.33 is obtained for a sphere, 0.5-0.6 for a coil shape and 1 for a rod. The vₕ obtained is 0.43. A linear relationship between Rh and M_{w} is obtained, meaning that the mannose polymers have similar conformations regardless of the degree of polymerization. A value of vₕ of 0.43 means that the mannose polymers adopt a conformation close to a sphere, which means that the mannose polymers have compact and/or hyperbranched structures. This statement is supported by the high solubility of mannose polymers in water (500 g/L).

### Example 2: Polymerization of Other Mono- and Disaccharides

Three mono- and four disaccharides were tested. Because induction periods vary with carbohydrate, plasma treatment was arbitrarily set at 30 min in all cases. The results are summarized in Table 1 below. Remarkably, the plasma is able to polymerize all the carbohydrates tested. Only the carbohydrates liquefying in the reactor (for example, fructose) could not be polymerized but a cooling of the plasma reactor should allow their polymerization. A difference in the induction period was observed between the different carbohydrates, which is related to a different activation temperature. When the disaccharides were used, it was observed by MALDI/TOF that the disaccharide unit was the basic unit of the polymer which suggests that the glycosidic bonds are not broken. As observed in the case of mannose, a white powder is obtained in all cases.

The structural parameters of the recovered polymers were determined as before. The average molar mass remains similar in all cases and ranges from 2,000 to 5,500 g/mol with a polydispersity ranging from 2 to 11. These values are however lower than those obtained from mannose. This result is not surprising and stems from the fact that the plasma has been optimized for mannose, while the parameters applied are certainly not the optimal parameters for each carbohydrate. This is the reason why the M_{w} and the conversions presented in Table 1 differ from those of mannose. Nevertheless, Table 1 clearly illustrates the plasma potential for the polymerization of carbohydrates under dry conditions. As previously carried out with the mannose polymers, the conformation of the polymers presented in Table 1 was studied by plotting Rh as a function of M_{w}. Again, a linear correlation was obtained. In particular, a vₕ of around 0.40 was obtained (values ranged from 0.37 to 0.44) indicating that the polysaccharides have very similar macromolecular structures. As previously mentioned, a vₕ of 0.40 indicates a compact and/or hyperbranched organization of polysaccharides. The formation of hyperbranched polysaccharides also confirms a disordered polymerization of carbohydrates. However, it is interesting to note that from the isomaltulose and turanose, the vₕ are lower suggesting an even more compact and/or hyperbranched appearance for the corresponding polysaccharides in agreement with the mass distribution profile.

TABLE 1
Polymerization of various plasma-induced carbohydrates

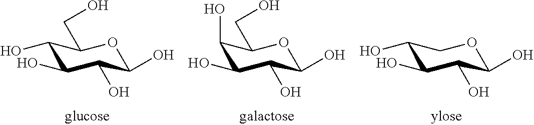

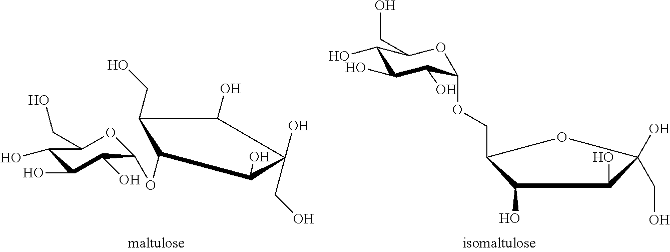

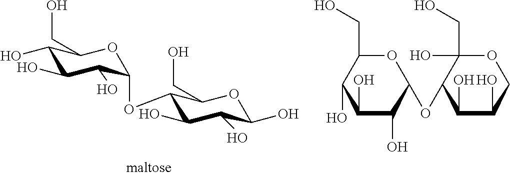

| | Induction | Polymerization | Conv | Mw | Mn | | | Rh | η | |
|---|---|---|---|---|---|---|---|---|---|---|
| Saccharides | period (min) | temp. (° C.) | (%) | (g/mol) | (g/mol) | Ð | DP | (nm) | (ml/g) | νₕ |
| Glucose | 15 | 66 | 70 | 5051 | 909 | 5.6 | 33 | 1.4 | 5.0 | 0.41 |
| Xylose | 10 | 56 | 90 | 5368 | 1121 | 5.3 | 45 | 1.4 | 5.3 | 0.42 |
| Galactose | 20 | 72 | 62 | 3378 | 302 | 11.2 | 28 | 0.8 | 3.5 | 0.44 |
| Maltulose | 7 | 40 | 92 | 3723 | 1746 | 2.1 | 26 | 1.2 | 4.2 | 0.4 |
| Maltose | 10 | 56 | 91 | 2325 | 835 | 2.8 | 15 | 1.0 | 4.2 | 0.42 |
| Isomaltulose | 15 | 64 | 87 | 3409 | 1207 | 2.8 | 25 | 1.0 | 3.5 | 0.38 |
| Turanose | 30 | 80 | 80 | 2214 | 581 | 3.8 | 18 | 0.8 | 3.2 | 0.37 |

1. A method for preparing a polysaccharide comprising a step of non-thermal plasma polymerization of a saccharide monomer, wherein the polymerization step is not carried out in the presence of a solid support.

2. The method according to claim 1, wherein the saccharide monomer is a monosaccharide or a disaccharide.

3. The method according to claim 1, wherein the saccharide monomer is a monosaccharide.

4. The method according to claim 1, wherein the polymerization step is carried out at a temperature below the melting temperature of the saccharide monomer.

5. The method according to claim 1, wherein the polymerization step is carried out at a temperature between 0° C. and 140° C.

6. The method according to claim 1, wherein the polymerization step is carried out for a period of less than 30 minutes.

7. The method according to claim 1, wherein the polysaccharide has a molar mass of from 1000 g/mol to 100,000 g/mol.

8. The method according to claim 1, characterized in that it does not include a subsequent purification step.

9. The method according to claim 1, comprising the steps of:
placing a saccharide monomer between two electrodes insulated from one another by a dielectric material;
application of an electric field greater than 5·10⁵ V/m between the two electrodes to generate a plasma discharge between the two electrodes; and
formation of a polysaccharide by the polymerization of the saccharide monomer.

10. The method of claim 1, wherein the polymerization step is carried out for a period between 5 and 20 minutes.
